(19) United States
(12) Patent Application Publication
(10) Pub. No.: US 2024/0373817 A1
(43) Pub. Date: Nov. 14, 2024

(54) MODULAR PET BOWL SYSTEM

(71) Applicant: Alden Martinez, Atlanta, GA (US)

(72) Inventor: Alden Martinez, Atlanta, GA (US)

(21) Appl. No.: 18/683,479

(22) PCT Filed: Aug. 15, 2022
(86) PCT No.: PCT/US2022/074977

§ 371 Date: Feb. 13, 2024

Related U.S. Application Data
(60) Provisional application No. 63/233,010, filed on Aug. 13, 2021.

(51) Int. Cl. A01K 5/01; A01K 7/00; F16M 13/02

(52) U.S. Cl. CPC A01K 5/0114; A01K 7/00; F16M 13/02

(57) ABSTRACT

A pet bowl system for use with domestic pets is described. The system includes multiple bowls which are configured to be mounted to a bowl holder via a horizontal rail system. The rail mount is configured to be expandable to accommodate additional iterations of the bowl(s). The bowls are designed to snap into place onto the rail mount. The rail mount is configured to be attached to a wall or similar vertical planar surface at the approximate height of the animals in use of the system. The bowls may be easily removed from the rail mount for cleaning and/or refilling when needed. At least one buckle may be employed to facilitate the attachment of one rail to another horizontally.

### CONTINUITY

This application is a PCT Utility Patent Application of provisional patent application No. 63/233,010, filed on Aug. 13, 2021, and priority is claimed thereto.

### FIELD OF THE PRESENT INVENTION

The present invention relates to the field of domestic pet care, and more specifically relates to a new form of pet bowl and rack system configured for use by domestic animals such as dogs and cats.

### BACKGROUND OF THE PRESENT INVENTION

It is known that domestic pets must be fed at regular intervals as they are unable to forage, especially when kept indoors. As such pet owners conventionally place specific food into bowls placed at or near ground level to serve as a medium for feeding their animals.

Unfortunately, most pet bowls are kept on the floor or are contained within a stand which sits on the floor. These methods take up additional space which can be at a premium in apartment or condominium living. Additionally, in settings housing multiple pets, such as pet shelters, there are often numerous pet bowls, two per pet-pen, each of which often must be repositioned to a corner or along the wall when an overzealous pet moves the bowl during feeding. Likewise, some wall-mounted pet bowl systems on the market require cutting into the drywall, which causes unnecessary damage to the wall.

If there were a way in which the pet bowl could be secured in position, movement of the pet bowl would be minimized. Additionally, if there were a way in which the pet bowls could easily be mounted to the wall, but also easily removed when cleaning is required, the height of the pet bowl(s) could easily be adjusted to be tailored to the height of the pet, the pet bowl would remain in position, and multiple pet bowls could be easily employed without difficulty. If there were a pet bowl system which did not require such permanent damage to the wall, more people would desire to use the system.

Thus, there is a need for a new form of pet bowl system and apparatus which is configured to be mounted to the wall via a rail mount. Such a system is preferably modular such that additional pet bowls can be added to the system by the user with ease. In this way, the feeding of multiple pets from different bowls simultaneously could be facilitated at the same or different heights. Additionally, such a pet bowl system enables the removal of the pet bowls easily from a rail mount without necessitating removal of the rail, expediting and facilitating cleaning and refilling of the pet bowls by a user.

### SUMMARY OF THE PRESENT INVENTION

The present invention is a pet bowl system and apparatus configured for use in domestic residences, pet shelters, and other conventional places domesticated animals are kept as pets. The system includes pet bowls, a rail mount configured to securely hold the pet bowls, and at least one mounting mechanism. The mounting mechanism preferably employs frictional tension within one or more plastic components of the rail mount. The rail mount is configured to be mounted to a wall or similar planar surface at a height corollary to that of the head of the pet(s) by which the present invention is to be used. The rail mount of the present invention, in some embodiments, is modular in that the user may connect multiple rail mounts together to accommodate additional pet bowls. The rail mounts are preferably affixed to the wall or other planar surface with up to three screws and/or wall anchors. The rail mounts preferably employ a clip and buckle to facilitate the connection of multiple rail mounts end-to-end. The ability to mount the pet bowls at the proper height of the pet(s) eating the food allows for better digestion of the food, and prevents the pet from having to bend over at the neck, squat, or lean over to eat the food.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts an isometric view of the pet bowl system of the present invention as seen from the front.

FIG. 2 depicts an isometric view of the pet bowl system of the present invention as seen from the rear.

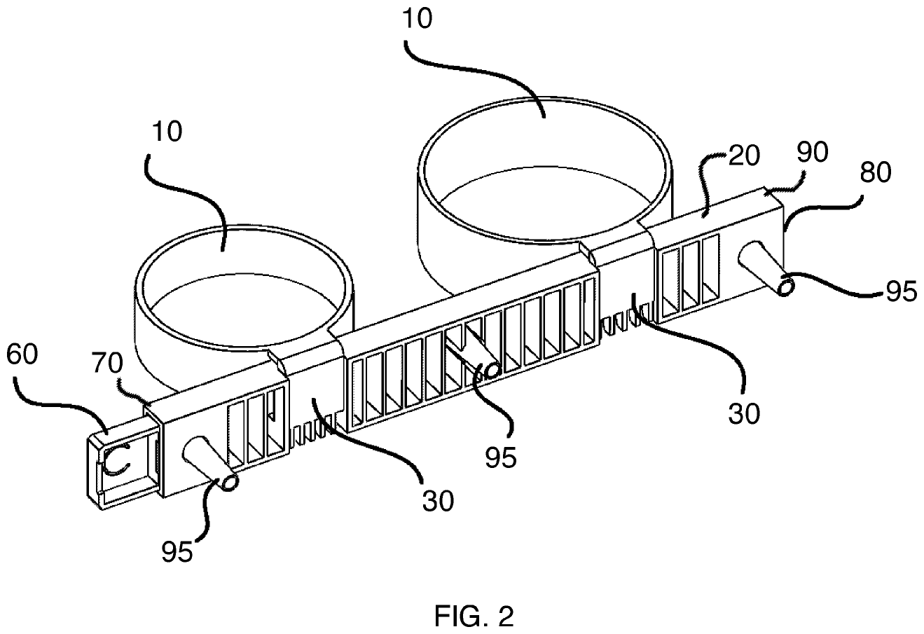

FIG. 3 shows a rear view of the mounting rail of the present invention.

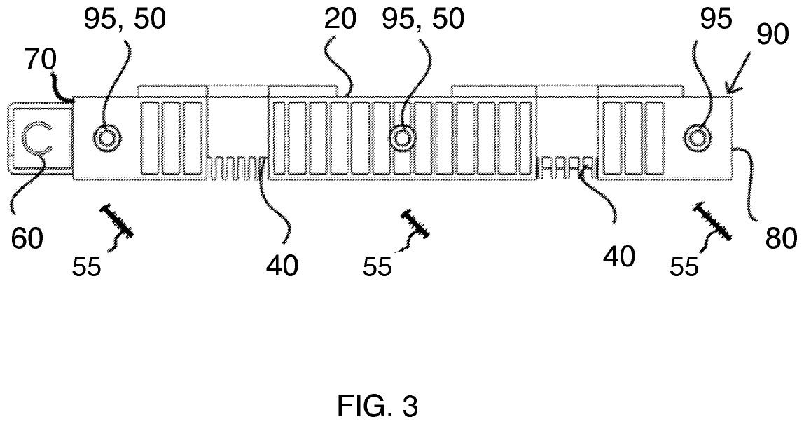

FIG. 4 exhibits a flow chart detailing the process of installation and use of the system of the present invention.

FIG. 5 depicts a view of the top of the apparatus of the present invention, showing the mounting rail connected to the bowls.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

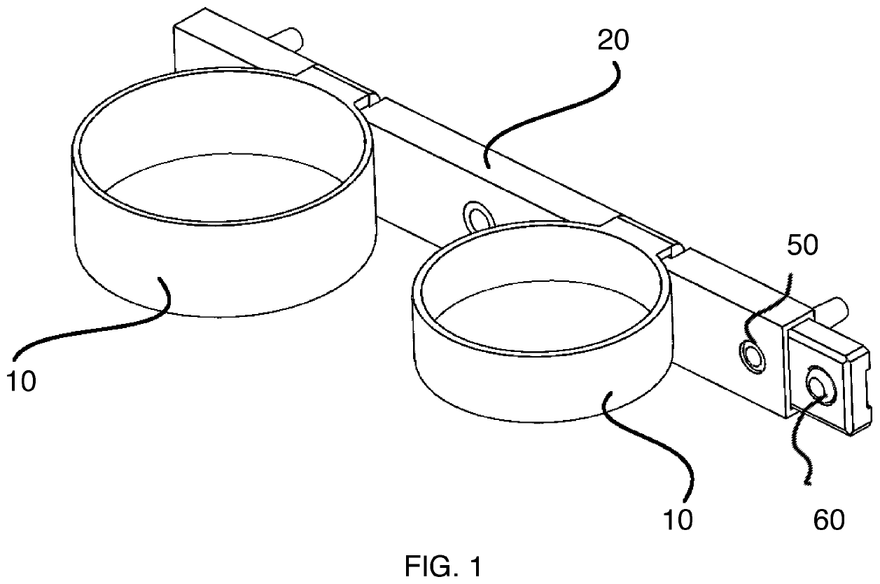

The present invention is a pet bowl system and apparatus configured for use by domesticated animals such as cats and dogs. As seen in FIG. 1, the preferred embodiment of the present invention includes pet bowls (10) and a mounting rail (20). The pet bowls (10) are preferably equipped with a male clip apparatus (30) configured to mate and attach to a female clip receptacle (40) disposed on the mounting rail (20). The mounting rail (20) is equipped with screw holes (50), a male buckle (60) disposed on a first end (70) and a female buckle (80) disposed on a second end (90) of the mounting rail (20). It should be understood that the male buckle (60) and female buckle (80) of iterations of the mounting rails (20) may be one of many conventional interlocking buckles configured to provide an easy means of disconnection as needed.

The system and apparatus of the present invention is modular in that the user may connect multiple mounting rails (20) together, end-to-end, by connecting the male buckle (60) of the first end (70) of a first iteration of mounting rail (20) to the female buckle (80) of the second end (90) of a second iteration of mounting rail (20). In such an arrangement, a user may serve up to four bowls simultaneously. This process may be continued, adding additional iterations of mounting rails (20), end-to-end, together to accommodate as many bowls (10) as needed via the buckles disposed on the first end (70) and second end (90) of the rails (20).

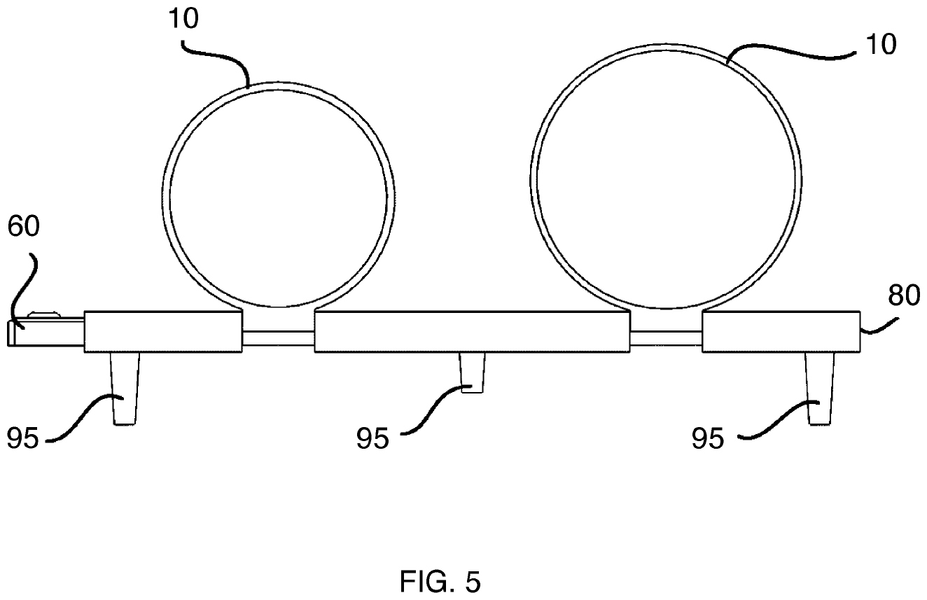

The screw holes (50) of the mounting rail (20) of the present invention are configured to accept screws (55) to facilitate the mounting of the mounting rail (20) to a wall or similar planar vertical surface securely. As such, it is envisioned that the mounting rail (20) components of the present invention remain in position installed to the wall. Conversely, the bowls (10) may easily be removed from the mounting rail by a user when cleaning is required. The bowls (10) are NSF food safe, and are easily removed from the mounting rail (20) for cleaning. The bowls (10) lock into the mounting rail (20) securely to prevent the pet from pushing the pet bowls (10) around and spilling their contents (food and water). The screw holes (50) may be present within protrusions (95) which extend out and away from the mounting rail (20) as shown in FIG. 5.

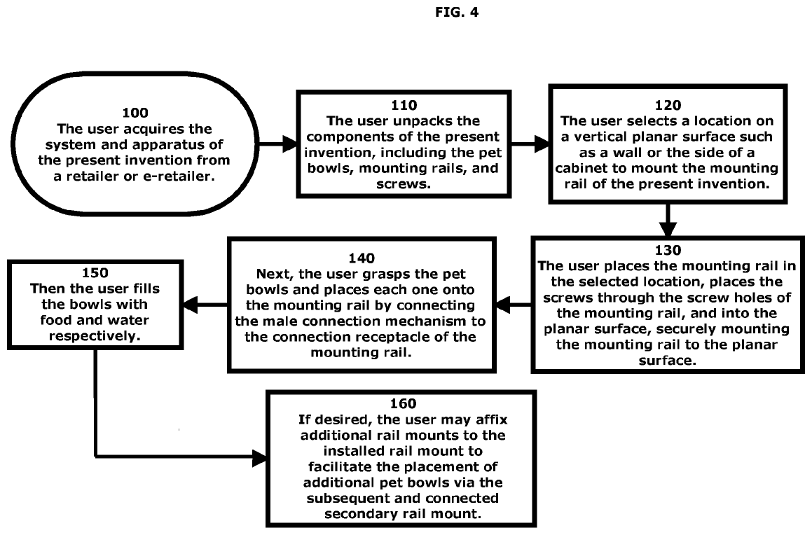

As depicted in FIG. 4, the process of installation and use of the system of the present invention is preferably as follows:
1. The user acquires the system and apparatus of the present invention from a retailer or e-retailer. (100)
2. The user unpacks the components of the present invention, including the pet bowls, mounting rails, and screws. (110)
3. The user selects a location on a vertical planar surface such as a wall or the side of a cabinet to mount the mounting rail of the present invention. (120)
4. The user places the mounting rail in the selected location, places the screws through the screw holes of the mounting rail, and into the planar surface, securely mounting the mounting rail to the planar surface. (130)
5. Next, the user grasps the pet bowls and places each one onto the mounting rail by connecting the male connection mechanism to the connection receptacle of the mounting rail. (140)
6. Then the user fills the bowls with food and water respectively. (150)
7. If desired, the user may affix additional rail mounts to the installed rail mount to facilitate the placement of additional pet bowls via the subsequent and connected secondary rail mount. (160)

It should be noted that, in the preferred embodiment of the present invention, the pet bowls (10) of the present invention are available in three primary sizes: Small, Medium, and Large. Additionally, customers may select a package based on the pet they have. In such packages, cat owners may select the cat package which contains pet bowls (10) having the shape of a cat head. Similarly, dog owners may select the dog package which contains pet bowls (10) having the shape of a dog head. It should be understood that the pet bowls (10) of the present invention are NSF food safe certified, and are preferably hand and/or dishwasher safe for easy cleaning. The mounting rail (20) may be composed of metal, plastic, or similar durable materials.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A wall-mounted pet food holding system comprising:
a mounting rail;
a first bowl, said first bowl equipped with a first male clip apparatus;
a second bowl, said second bowl equipped with a second male clip apparatus;
a mounting rail, said mounting rail equipped with a first female clip receptacle and a second female clip receptacle;
screw holes, said screw holes present in said mounting rail;
wherein said first bowl is configured to be removably connected to said mounting rail when said first male clip apparatus is inserted into said first female clip receptacle; and
wherein said second bowl is configured to be removably connected to said mounting rail when said second male clip apparatus is inserted into said second female clip receptacle.

2. The system of claim 1, further comprising:
screws, said screws configured to connect said mounting rail to the wall via said screw holes.

3. The system of claim 1, further comprising:
protrusions, said protrusions providing a shroud for said screws.

4. The system of claim 1, further comprising:
a male buckle disposed on a first end of said mounting rail;
a female buckle disposed on a second end of said mounting rail;
a second mounting rail, identical to said mounting rail; and
wherein said second mounting rail is configured to connect to said mounting rail by connecting said male buckle of said mounting rail to said female buckle of said second mounting rail.

5. The system of claim 1, wherein said mounting rail is composed of plastic.

6. The system of claim 1, wherein said mounting rail is composed of metal.

7. The system of claim 1, wherein said first bowl and said second bowl are NSF food safe certified; and
wherein said first bowl and said second bowl are dishwasher safe.

8. The system of claim 1, wherein said first bowl and said second bowl are of one of the following sizes: large, medium, and small.

9. The system of claim 1, wherein said first bowl and said second bowl exhibit the shape of an outline of a cat's head.

10. The system of claim 1, wherein said first bowl and said second bowl exhibit the shape of an outline of a dog's head.

11. The system of claim 2, further comprising:
protrusions, said protrusions providing a shroud for said screws.

12. The system of claim 2, further comprising:
a male buckle disposed on a first end of said mounting rail;
a female buckle disposed on a second end of said mounting rail;
a second mounting rail, identical to said mounting rail; and
wherein said second mounting rail is configured to connect to said mounting rail by connecting said male buckle of said mounting rail to said female buckle of said second mounting rail.

13. The system of claim 12, wherein said first bowl and said second bowl are NSF food safe certified; and
wherein said first bowl and said second bowl are dishwasher safe.

14. The system of claim 13, wherein said mounting rail is composed of plastic.

15. A method for installing a wall-mounted pet food system comprising:
selecting a location of installation on a vertical planar surface such as the wall;
placing a mounting rail in the selected location;
placing screws through screw holes present within the mounting rail and into the planar surface, securely mounting the mounting rail to the planar surface;
grasping a first pet bowl and placing it onto the mounting rail by inserting a first male clip apparatus present on the first pet bowl into a first female clip receptacle present on the mounting rail, removably securing the first pet bowl to the mounting rail;
grasping a second pet bowl and placing it onto the mounting rail by inserting a second male clip apparatus present on the second pet bowl into a second female clip receptacle present on the mounting rail, removably securing the second bet bowl to the mounting rail;
filling the first pet bowl with pet food; and
filling the second pet bowl with water.

16. The method of claim 15, wherein the first pet bowl and second pet bowl exhibit the shape of a cat's head.

17. The method of claim 15, wherein the first pet bowl and second pet bowl exhibit the shape of a dog's head.

18. The method of claim 15, further comprising:
connecting a subsequent mounting rail to the initial mounting rail via buckles, providing a mounting location for a third pet bowl and fourth pet bowl.

19. The method of claim 15, further comprising:
removing the first pet bowl from the mounting rail by lifting up on the first pet bowl, separating the male clip apparatus of the first pet bowl from the female clip receptacle of the mounting rail;
cleaning the first pet bowl;
removing the second pet bowl from the mounting rail by lifting up on the second pet bowl, separating the male clip apparatus of the second pet bowl from the female clip receptacle of the mounting rail; and
cleaning the second pet bowl.
